(19) United States
(12) Patent Application Publication
(10) Pub. No.: US 2025/0138617 A1
(43) Pub. Date: May 1, 2025

(54) ELECTRONIC APPARATUS

(71) Applicant: Panasonic Intellectual Property Management Co., Ltd., Osaka (JP)

(72) Inventors: Akihito MORISHIGE, Hyogo (JP); Takuya YASUNAGA, Osaka (JP); Masamitsu MURASE, Kyoto (JP); Yusaku NAKAMURA, Osaka (JP); Makoto OCHI, Osaka (JP)

(73) Assignee: Panasonic Intellectual Property Management Co., Ltd., Osaka (JP)

(21) Appl. No.: 19/004,355

(22) Filed: Dec. 29, 2024

Related U.S. Application Data
(63) Continuation of application No. PCT/JP2023/024862, filed on Jul. 5, 2023.

(30) Foreign Application Priority Data
Aug. 5, 2022 (JP) 2022-125447

(51) Int. Cl. G06F 1/3212; G06F 3/01; G09G 5/10

(52) U.S. Cl. CPC G06F 1/3212; G06F 3/013; G09G 5/10; G09G 2320/0626; G09G 2330/021; G09G 2354/00

(57) ABSTRACT

An electronic apparatus of the present disclosure is an electronic apparatus including: a plurality of devices; a battery that supplies driving power to the plurality of devices; a sensor that detects a use state of the electronic apparatus used by a user; and a control unit that controls the plurality of devices, the battery, and the sensor, in which when the battery is connected to a power source, the control unit selects a device allowed to be reduced in power consumption among the plurality of devices based on the use state, and performs control for reducing the power consumption of the device selected.

### TECHNICAL FIELD

The present disclosure relates to an electronic apparatus.

### BACKGROUND ART

PTL 1 discloses a mobile terminal that cancels a display state of a display screen by display-off, display brightness reduction, or the like when the display screen is detected not being viewed by a user.

### CITATION LIST

### Patent Literature

PTL 1: Unexamined Japanese Patent Publication No. 2009-267644

### SUMMARY OF THE INVENTION

The mobile terminal described in PTL 1 still has room for improvement in terms of extending battery driving time.

The present disclosure provides an electronic apparatus capable of extending battery driving time.

An electronic apparatus according to an aspect of the present disclosure is an electronic apparatus including: a plurality of devices; a battery that supplies driving power to the plurality of devices; a sensor that detects a use state of the electronic apparatus used by a user; and a control unit that controls the plurality of devices, the battery, and the sensor, in which when the battery is connected to a power source, the control unit selects a device allowed to be reduced in power consumption among the plurality of devices based on the use state, and performs control for reducing the power consumption of the device selected.

The present disclosure enables providing an electronic apparatus capable of extending battery driving time.

### BRIEF DESCRIPTION OF THE DRAWINGS

FIG. 1 is a block diagram illustrating a configuration of an electronic apparatus according to a first exemplary embodiment of the present disclosure.

FIG. 2 is a flowchart illustrating operation of the electronic apparatus of FIG. 1.

FIG. 3 is a flowchart illustrating operation of an electronic apparatus according to a second exemplary embodiment.

FIG. 4 is a block diagram illustrating a configuration of an electronic apparatus according to a third exemplary embodiment.

FIG. 5 is a flowchart illustrating operation of the electronic apparatus of FIG. 4.

### DESCRIPTION OF EMBODIMENT

### Background to Present Disclosure

Electronic apparatuses such as laptop PCs and tablet terminals are often carried and used. This kind of portable electronic apparatus is supplied with electric power from a built-in battery. Usable time of the battery greatly depends on power consumption of an application executed by the electronic apparatus.

Examples of a technique for reducing power consumption of an electronic apparatus includes that of PTL 1. The mobile terminal described in PTL 1 cancels maintenance of a display state of the display screen by display-off, display brightness reduction, or the like when the display screen is detected not being viewed by a user. Unfortunately, there is a problem that the display-off or the display brightness reduction does not achieve a sufficient power saving effect, and thus the battery driving time cannot be sufficiently extended.

Various devices are connected to the electronic apparatus in addition to a display unit. When the user is not using the electronic apparatus, for example, a larger power saving effect can be obtained by reducing power consumption of each device.

Thus, the inventors of the present invention have studied to extend driving time of a battery by selecting a device allowed to be reduced in power consumption and reducing the power consumption of the device selected to reduce power consumption of the electronic apparatus while the battery is connected to an AC adapter, and thus having reached the invention below.

Hereinafter, an exemplary embodiment of the present disclosure will be described with reference to accompanying drawings. The following description is merely exemplary in nature, and is not intended to limit the present disclosure, its application, or its use. The drawings are also each schematic, so that a ratio of each dimension and the like does not necessarily equal to an actual dimension.

### First Exemplary Embodiment

### [General Configuration]

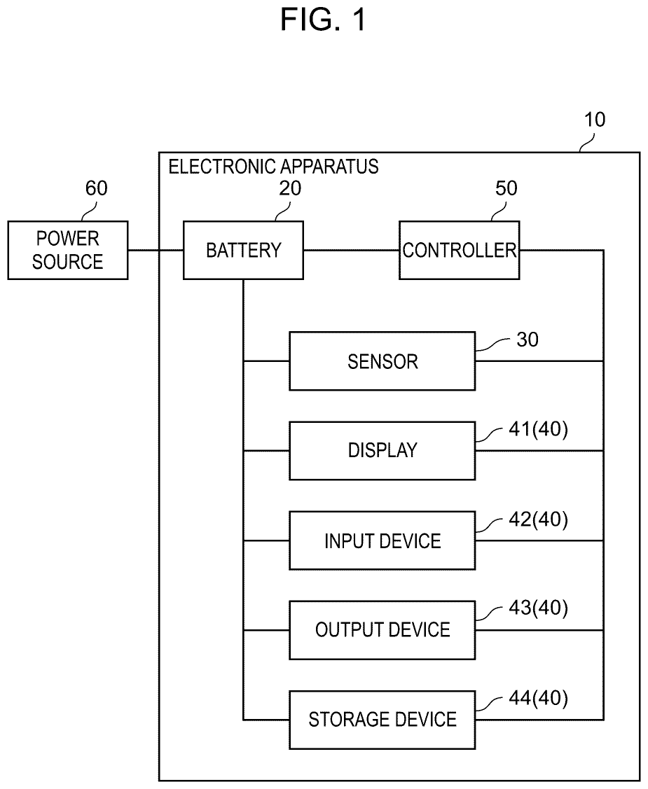

FIG. 1 is a block diagram illustrating a configuration of electronic apparatus 10 according to a first exemplary embodiment of the present disclosure.

Electronic apparatus 10 is an information processing terminal to which driving power is supplied from a battery, such as a laptop PC, a tablet terminal, or a smartphone. Electronic apparatus 10 includes battery 20, sensor 30, a plurality of devices 40 including display 41, input device 42, output device 43, and storage device 44, and control unit 50.

Battery 20 is detachably mounted on electronic apparatus 10 and supplies driving power to electronic apparatus 10. Battery 20 is composed of a secondary battery such as a lithium ion battery, for example. Battery 20 can be repeatedly charged by being connected to external power source 60 using an AC adapter, for example.

Sensor 30 detects a use state of the electronic apparatus used by a user. The use state of the electronic apparatus used by the user is information indicating whether the user is in a state of using electronic apparatus 10, such as whether the user is in front of electronic apparatus 10 or whether a line of sight of the user is directed to display 41, for example.

Sensor 30 may be a camera capable of detecting the line of sight of the user, for example. Sensor 30 may be also a human sensor using ultrasonic waves, visible light, or infrared rays, for example. Alternatively, sensor 30 may be glasses or other wearable devices capable of detecting the line of sight of the user. In the present exemplary embodiment, an example will be described in which sensor 30 is a camera for detecting the line of sight of the user.

Examples of the plurality of devices 40 include a device built in electronic apparatus 10 and a device connected using a connection terminal such as a USB mounted on electronic apparatus 10. Examples of devices 40 include input device 42, output device 43, and storage device 44. Display 41 is a type of output device 43 and corresponds to a “display device” of the present disclosure. Devices 40 may also include a network adapter (not illustrated) for performing wireless communication or wired communication.

Input device 42 is a device for giving data, information, an instruction, or the like to electronic apparatus 10. Examples of input device 42 include a keyboard, a mouse, a touch panel, and a microphone.

Output device 43 is a device for receiving data from a program executed by control unit 50 and presenting the data in a format recognizable by the user. Examples of output device 43 include display 41, a projector, a printer, and a speaker.

Storage device 44 is a device for storing a program or data to be executed by control unit 50 or functioning as a work region of control unit 50. Examples of storage device 44 include a memory, a hard disk drive (HDD), and a solid state drive (SDD).

In the present exemplary embodiment, every device 40 is driven using driving power supplied from battery 20.

Control unit 50 functions as a controller that controls the whole electronic apparatus 10, and controls battery 20, sensor 30, and the plurality of devices 40. Control unit 50 includes a processor that implements a predetermined function by executing a program stored in storage device 44. Control unit 50 is not limited to one that implements a predetermined function by cooperation of hardware and software, and may be a hardware circuit designed to implement the predetermined function. That is, control unit 50 can be composed of various processors such as a microcomputer, a CPU, an MPU, a GPU, a DSP, an FPGA, and an ASIC, for example.

### [Operation]

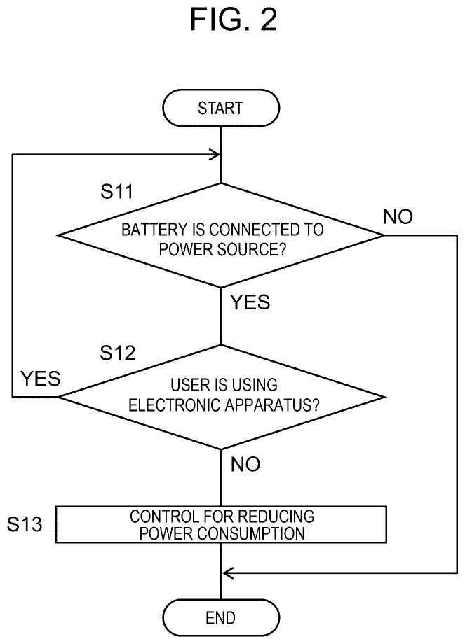

FIG. 2 is a flowchart illustrating operation of electronic apparatus 10 of FIG. 1. With reference to FIG. 2, operation of electronic apparatus 10 will be described.

In step S11, control unit 50 determines whether battery 20 is connected to power source 60. When battery 20 is not connected to power source 60, processing ends. When battery 20 is connected to power source 60, the processing proceeds to step S12.

When battery 20 is connected to power source 60, control unit 50 in step S12 determines whether the user is using electronic apparatus 10. In the present exemplary embodiment, it is determined whether the user is using electronic apparatus 10 depending on a direction of the line of sight of the user. The direction of the line of sight of the user is information indicating a place at which the user is looking. For example, when the line of sight of the user is not directed to display 41, the user is not looking at display 41, and thus control unit 50 can determine that the user is not using electronic apparatus 10. Conversely, when the line of sight of the user is directed to display 41, for example, the user is looking at display 41, and thus control unit 50 can determine that the user is using electronic apparatus 10.

Thus, when sensor 30 detects that the line of sight of the user is directed to display 41, control unit 50 determines that the user is using electronic apparatus 10. When sensor 30 detects that the line of sight of the user is not directed to display 41, control unit 50 determines that the user is not using electronic apparatus 10. That is, control unit 50 determines whether the user is using electronic apparatus 10 based on a use state such as a direction of the line of sight of the user, the use state being detected by sensor 30.

Alternatively, control unit 50 may determine that the user is not using electronic apparatus 10 when the line of sight of the user is not continuously directed to display 41 for a predetermined time. Control unit 50 can determine that the user is not using electronic apparatus 10 when the line of sight of the user is not continuously directed to display 41 for thirty seconds or more, for example.

When the user is using electronic apparatus 10, i.e., when the line of sight of the user is directed to display 41, the processing returns to step S11, and control unit 50 again determines whether battery 20 is connected to power source 60. When the user is not using electronic apparatus 10, i.e. when the line of sight of the user is not directed to display 41, the processing proceeds to step S13.

When control unit 50 determines that the user is not using electronic apparatus 10, control unit 50 selects a device allowed to be reduced in power consumption among the plurality of devices 40 in step S13 to perform control for reducing the power consumption of device 40 selected. Examples of the device allowed to be reduced in power consumption include device 40 that does not affect driving of electronic apparatus 10. For example, a device such as a network adapter affects driving of electronic apparatus 10 when being turned off, and thus is not included in the device allowed to be reduced in power consumption. When it is determined that the user is not using electronic apparatus 10, control unit 50 can select a plurality of devices 40 that does not affect the driving of electronic apparatus 10, such as devices 40 other than the network adapter, as devices allowed to be reduced in power consumption.

Alternatively, control unit 50 may select unused device 40 as a device allowed to be reduced in power consumption. When the line of sight of the user is not directed to display 41, control unit 50 can select display 41 as a device allowed to be reduced in power consumption, for example. When audio is being reproduced in electronic apparatus 10, control unit 50 can select device 40 other than a speaker, included in output device 43, as a device allowed to be reduced in power consumption, for example. When audio input is being performed to electronic apparatus 10, control unit 50 can select device 40 other than a microphone included in input device 42 as a device allowed to be reduced in power consumption, for example. Thus, when the line of sight of the user is not directed to display 41, control unit 50 selects device 40 not being used as a device allowed to be reduced in power consumption. Control unit 50 may select one device 40 or a plurality of devices 40 each as a device allowed to be reduced in power consumption. Control unit 50 performs the control for reducing the power consumption on device 40 selected. Examples of the control for reducing the power consumption include reducing brightness of display 41, turning off device 40 selected, and reducing operation frequency of the processor.

When the line of sight of the user is not directed to display 41, control unit 50 determines that the user is not using electronic apparatus 10, and performs control for lowering brightness of display 41 or turn off display 41. Alternatively, control unit 50 may turn off device 40 that does not affect driving of electronic apparatus 10. As a result, the power consumption of electronic apparatus 10 can be reduced without impairing convenience of the user. Control unit 50 may also turn off device 40 other than display 41. Turning off corresponding device 40 when control unit 50 determines that the user is not using electronic apparatus 10 enables further reduction in the power consumption of electronic apparatus 10.

When battery 20 is connected to power source 60, the sum of power supplied from power source 60 to electronic apparatus 10 and power charged from power source 60 to battery 20 is constant. That is, power source 60 supplies power for charging battery 20 using power reserved from power to be supplied as the power consumption of electronic apparatus 10. Thus, the control for reducing the power consumption includes control for increasing charging power of battery 20. Increasing the charging power of battery 20 means increasing a current for charging battery 20. Performing the control not only for reducing the power consumption but also for increasing the charging power of battery 20 when power source 60 is connected to battery 20 enables charging time of battery 20 to be shortened. Shortening the charging time of battery 20 enables available driving time of battery 20 to be extended.

When control unit 50 performs the control for reducing the power consumption in step S13, the processing ends.

### Effects

The exemplary embodiment described above enables achieving effects below.

Electronic apparatus 10 includes battery 20, sensor 30, the plurality of devices 40, and control unit 50. Battery 20 supplies driving power to electronic apparatus 10. Sensor 30 detects a use state of electronic apparatus 10 used by the user. The plurality of devices 40 is driven by driving power from battery 20. Control unit 50 controls battery 20, sensor 30, and the plurality of devices 40. When battery 20 is connected to power source 60, control unit 50 selects device 40 allowed to be reduced in power consumption among the plurality of devices 40 based on the use state, and performs control for reducing the power consumption of device 40 selected.

This kind of configuration enables providing an electronic apparatus capable of extending driving time of a battery. Power saving effect can be enhanced by selecting device 40 allowed to be reduced in power consumption among the plurality of devices 40 depending on the use state of electronic apparatus 10 used by the user and reducing power consumption of device 40 selected. As a result, the driving time of battery 20 can be extended. Increasing the power for charging battery 20 when the power consumption of electronic apparatus 10 is reduced enables the charging time of battery 20 to be shortened. When the charging power of battery 20 is increased, the driving power of the plurality of devices 40 decreases, and thus performance of electronic apparatus 10 deteriorates. In the present exemplary embodiment, the charging power of battery 20 can be increased by selecting device 40 allowed to be reduced in power consumption and reducing power consumption of device 40 selected. Thus, charging efficiency of the battery can be improved without deteriorating performance.

Sensor 30 includes a camera for detecting the line of sight of the user. Device 40 includes display 41. When detecting that the line of sight of the user is not directed to display 41, control unit 50 performs the control for reducing the power consumption.

Examples of the control for reducing the power consumption include reducing brightness of display 41.

This kind of configuration enables brightness of display 41 to be lowered when the line of sight of the user is not directed to display 41. Thus, the power consumption of electronic apparatus 10 can be reduced without impairing the convenience of the user.

Control unit 50 includes a processor. The control for reducing the power consumption includes reducing operation frequency of the processor.

This kind of configuration enables further reduction in the power consumption of electronic apparatus 10.

Although an example has been described in the exemplary embodiment described above, in which sensor 30 is a camera for detecting the line of sight of the user, the present invention is not limited thereto. For example, sensor 30 may include a human sensor that detects whether the user is in front of electronic apparatus 10, and control unit 50 may perform the control for reducing the power consumption when sensor 30 detects that the user is not in front of electronic apparatus 10. When sensor 30 detects that the user is in front of electronic apparatus 10, control unit 50 can determine that the user is using electronic apparatus 10. In contrast, when sensor 30 detects that the user is not in front of electronic apparatus 10, control unit 50 can determine that the user is not using electronic apparatus 10.

This kind of configuration enables achieving a simpler configuration.

Although an example has been described in the exemplary embodiment described above, in which electronic apparatus 10 includes the plurality of devices 40, the present invention is not limited thereto. Electronic apparatus 10 may include at least one device of output device 43, input device 42, and storage device 44.

Although an example has been described in the exemplary embodiment described above, in which control unit 50 selects device 40 that is not used as a device allowed to be reduced in power consumption, the present invention is not limited thereto. Control unit 50 may select device 40 being used as the device allowed to be reduced in power consumption.

Although an example has been described in the exemplary embodiment described above, in which control unit 50 turns off device 40 that is not used, the present invention is not limited thereto. Control unit 50 may turn off device 40 being used.

Although an example has been described in the exemplary embodiment described above, in which examples of the device allowed to be reduced in power consumption do not include a device that affects driving of electronic apparatus 10, such as a network adapter, the present invention is not limited thereto. The examples of the device allowed to be reduced in power consumption may include a device that affects driving of electronic apparatus 10 such as the network adapter.

### Second Exemplary Embodiment

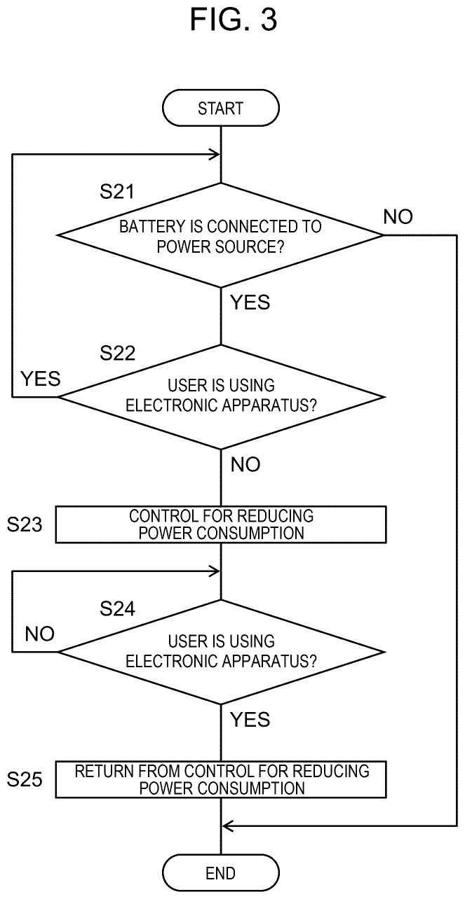

With reference to FIG. 3, a second exemplary embodiment will be described. The second exemplary embodiment includes components identical or equivalent to those in the first exemplary embodiment, the components being denoted by the same reference marks as those in the first exemplary embodiment. The second exemplary embodiment does not duplicate the description in the first exemplary embodiment.

FIG. 3 is a flowchart illustrating operation of electronic apparatus 10 according to the second exemplary embodiment. The second exemplary embodiment is different from the first exemplary embodiment in that control unit 50 performs the control for reducing the power consumption, and then causes a return from the control for reducing the power consumption based on a use state. Electronic apparatus 10 is similar in configuration to that of the first exemplary embodiment, and thus the configuration is not described.

Processing performed in each of steps S21 to S23 in FIG. 3 is similar to that in corresponding one of steps S11 to S13 in the first exemplary embodiment. In step S23, control unit 50 selects device 40 allowed to be reduced in power consumption and then performs the control for reducing the power consumption of device 40 elected. In step S24, control unit 50 subsequently determines whether the user is using electronic apparatus 10.

When control unit 50 in step S24 determines that the user is not using electronic apparatus 10, step S24 is repeated. That is, while the user is not using electronic apparatus 10, the control for reducing the power consumption is continued. Control unit 50 enables the processing in step S24 to be performed at predetermined time intervals, for example.

When control unit 50 in step S24 determines that the user is using electronic apparatus 10, the processing proceeds to step S25.

In step S25, control unit 50 causes the return from the control for reducing the power consumption. Specifically, when brightness of display 41 is lowered in step S23, for example, control unit 50 returns the brightness of display 41 to original brightness in step S25. When the plurality of devices 40 is turned off in step S23, for example, control unit 50 turns on the plurality of devices 40 in step S25. When operation frequency of the CPU is lowered in step S23, for example, control unit 50 returns the operation frequency of the CPU to an original value in step S25. In step S25, control unit 50 causes the return from the control for reducing the power consumption, and then the processing ends. Examples of the return from the control for reducing the power consumption include control for returning charging power of battery 20 to original power.

As described above, control unit 50 performs the control for reducing the power consumption in step S23, and then causes the return from the control for reducing the power consumption in step S25 based on a use state of electronic apparatus 10 used by the user, in the present exemplary embodiment. Specifically, control unit 50 performs the control for reducing the power consumption in step S25 when the line of sight of the user is not directed to display 41, and then causes the return from the control for reducing the power consumption when the line of sight of the user is directed to display 41 again. The return from the control for reducing the power consumption can be achieved without particular consciousness of the user. Thus, the power consumption of electronic apparatus 10 can be reduced and the driving time of battery 20 can be extended without impairing the convenience of the user.

### Effects

The exemplary embodiment described above enables achieving effects below.

Control unit 50 performs the control for reducing the power consumption, and then causes the return from the control for reducing the power consumption based on a use state. Specifically, control unit 50 performs the control for reducing the power consumption, and then causes the return from the control for reducing the power consumption when the sensor 30 detects that the line of sight of the user is directed to display 41.

This kind of configuration enables the power consumption of electronic apparatus 10 to be reduced, and the driving time of battery 20 to be extended without impairing the convenience of the user.

Although an example has been described in the exemplary embodiment described above, in which control unit 50 performs the control for reducing the power consumption, and then causes the return from the control for reducing the power consumption when it is detected that the line of sight of the user is directed to display 41, the present invention is not limited thereto. For example, control unit 50 may cause the return from the control for reducing the power consumption based on input to input device 42. More specifically, control unit 50 performs the control for reducing the power consumption, such as turning off another device 40 or reducing brightness of display 41, in step S23 while a predetermined input device 42, such as a keyboard or a mouse, is kept turned on. After that, control unit 50 in step S24 can determine that the user is in a state of using electronic apparatus 10 when input device 42 receives any input. Examples of the input to input device 42 include pressing of a predetermined key of the keyboard and pressing of a predetermined button of the mouse.

This kind of configuration also enables the return from the control for reducing the power consumption based on an instruction of the user, and thus the convenience of the user is further improved.

### Third Exemplary Embodiment

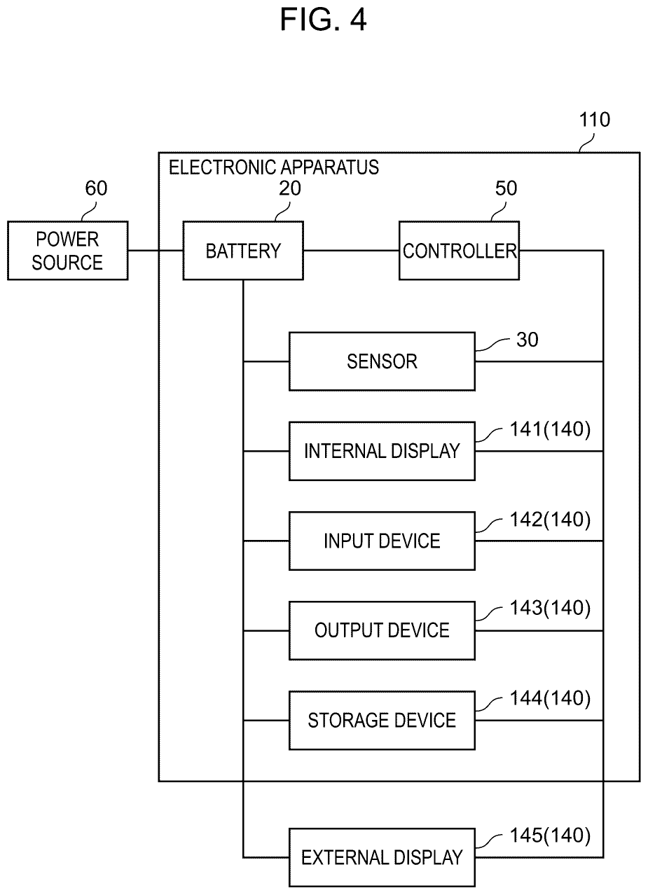

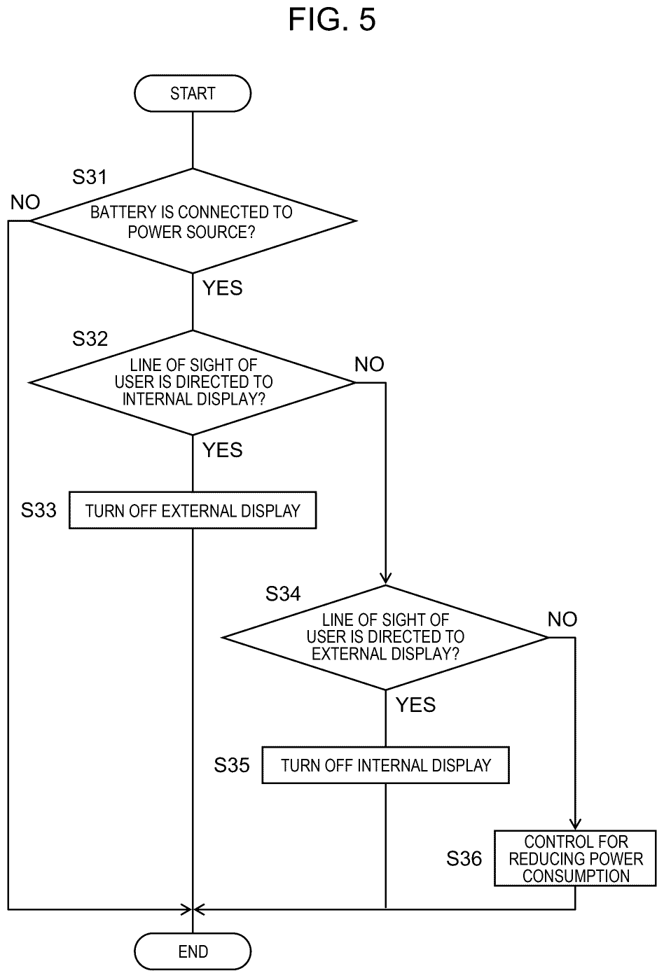

With reference to FIGS. 4 and 5, a third exemplary embodiment will be described. The third exemplary embodiment denotes components identical or equivalent to those in the first exemplary embodiment with the same reference marks as those in the first exemplary embodiment. The third exemplary embodiment does not duplicate the description in the first exemplary embodiment.

FIG. 4 is a block diagram illustrating a configuration of electronic apparatus 110 according to the third exemplary embodiment. FIG. 5 is a flowchart illustrating operation of electronic apparatus 110 of FIG. 4. The third exemplary embodiment is different from the second exemplary embodiment in that external display 145 is externally connected to electronic apparatus 110. External display 145 is also referred to as an external display device.

In the present exemplary embodiment, a plurality of devices 140 includes input device 142, output device 143, and storage device 144. The plurality of devices 140 further includes internal display 141 built into electronic apparatus 110 and external display 145 externally attached to electronic apparatus 110. External display 145 is connected to electronic apparatus 110 by using a USB, for example, and is supplied with driving power from battery 20 of electronic apparatus 110. Connecting external display 145 to electronic apparatus 110 enables the user to expand a display area of internal display 141 to external display 145.

In the present exemplary embodiment, control unit 50 performs control for turning off one of internal display 141 and external display 145, to which the line of sight of the user is not directed.

With reference to FIG. 5, operation of electronic apparatus 110 will be described.

In step S31, control unit 50 determines whether battery 20 is connected to a power source. When battery 20 is not connected to the power source, processing ends. When battery 20 is connected to the power source, the processing proceeds to step S32.

In step S32, control unit 50 determines whether the line of sight of the user is directed to internal display 141. When the line of sight of the user is directed to internal display 141, the processing proceeds to step S33. When the line of sight of the user is not directed to internal display 141, the processing proceeds to step S34.

When the line of sight of the user is directed to internal display 141, control unit 50 can determine that the user is using internal display 141 without using external display 145. Thus, control unit 50 turns off external display 145 and ends the processing in step S33.

When the line of sight of the user is not directed to internal display 141, control unit 50 in step S34 determines whether the line of sight of the user is directed to external display 145. When the line of sight of the user is directed to external display 145, the processing proceeds to step S35. When the line of sight of the user is not directed to external display 145, the processing proceeds to step S36.

When the line of sight of the user is directed to external display 145, control unit 50 can determine that the user is using external display 145 without using internal display 141. Thus, control unit 50 turns off internal display 141 and ends the processing in step S35.

When the line of sight of the user is not directed to external display 145, control unit 50 can determine that the user is not using electronic apparatus 110 because the user is not using both internal display 141 and external display 145. Thus, control unit 50 in step S36 selects device 140 allowed to be reduced in power consumption and performs the control for reducing the power consumption of device 140 selected. The control for reducing the power consumption is similar to that described in the first exemplary embodiment. When control unit 50 performs the control for reducing the power consumption, the processing ends.

### Effects

The exemplary embodiment described above enables achieving effects below.

Electronic apparatus 110 includes internal display 141 that is built-in and external display 145 that is externally attached. When the line of sight of the user is directed to one of the displays, control unit 50 turns off the other display.

This kind of configuration when the plurality of displays 141, 145 is provided enables reducing power consumption by turning off the display that is not used even when the user is using electronic apparatus 110. Thus, even when the user is using electronic apparatus 110, driving time of battery 20 can be extended by reducing the power consumption.

Although an example has been described in the exemplary embodiment described above, in which when the line of sight of the user is directed to one display, control unit 50 turns off the other display, the present invention is not limited thereto. When the user faces one display, control unit 50 may perform control for lowering brightness of the other display.

### Overview of Exemplary Embodiments

(1) An electronic apparatus according to the present disclosure is an electronic apparatus including: a battery that supplies driving power to the electronic apparatus; a sensor that detects a use state of the electronic apparatus used by a user; a plurality of devices that is driven by the driving power from the battery; and a control unit that controls the battery, the sensor, and the plurality of devices, in which when the battery is connected to a power source, the control unit selects a device allowed to be reduced in power consumption among the plurality of devices based on the use state, and performs control for reducing the power consumption of the device selected.

(2) In the electronic apparatus according to (1), the control unit performs control for increasing charging power of the battery based on the use state.

(3) In the electronic apparatus according to (1) or (2), the sensor may include a camera for detecting a line of sight of the user, the plurality of devices may include a display device, and the control unit may perform the control for reducing the power consumption when it is detected that the detected line of sight of the user is not directed to the display device.

(4) In the electronic apparatus according to (3), the control for reducing the power consumption may include reducing brightness of the display device.

(5) In the electronic apparatus according to (3) or (4), the control unit may perform the control for reducing the power consumption, and then cause a return from the control for reducing the power consumption when the sensor detects that the line of sight of the user is directed to the display device.

(6) In the electronic apparatus according to any one of (1) to (5), the sensor may include a human sensor that detects whether the user is in front of the electronic apparatus, and the control unit may perform the control for reducing the power consumption when the user is not in front of the electronic apparatus.

(7) In the electronic apparatus according to any one of (1) to (6), the plurality of devices may include at least one of an output device, an input device, and a storage device, and the control for reducing the power consumption may include turning off at least one of the plurality of devices.

(8) In the electronic apparatus according to any one of (1) to (7), the control unit may include a processor, and the control for reducing the power consumption may include reducing operation frequency of the processor.

(9) In the electronic apparatus according to any one of (1) to (8), the control unit may perform the control for reducing the power consumption, and then cause the return from the control for reducing the power consumption based on the use state.

(10) In the electronic apparatus according to any one of (1) to (9), the one or more devices may include an input device, and the control unit may perform the control for reducing the power consumption and then cause the return from the control for reducing the power consumption based on an input to the input device.

(11) In the electronic apparatus according to (3), when the electronic apparatus is connected to an external display device, the control unit may perform the control for reducing the power consumption of the external display device when the line of sight of the user is directed to the display device.

(12) In the electronic apparatus according to (3), when the electronic apparatus is connected to an external display device, the control unit may perform the control for reducing the power consumption of the display device when the line of sight of the user is directed to the external display device.

### INDUSTRIAL APPLICABILITY

The present disclosure is applicable to an electronic apparatus to which driving power is supplied from a battery.

### REFERENCE MARKS IN THE DRAWINGS

10, 110: electronic apparatus
20: battery
30: sensor
40, 140: device
41: display
42, 142: input device
43, 143: output device
44, 144: storage device
50: control unit
60: power source
141: internal display
145: external display

1. An electronic apparatus comprising:
a plurality of devices;
a battery that supplies driving power to the plurality of devices;
a sensor that detects a use state of the electronic apparatus used by a user; and
a control unit that controls the plurality of devices, the battery, and the sensor,
wherein when the battery is connected to a power source, the control unit selects a device allowed to be reduced in power consumption among the plurality of devices based on the use state, and performs control for reducing the power consumption of the selected device.

2. The electronic apparatus according to claim 1, wherein the control unit performs control for increasing charging power of the battery based on the use state.

3. The electronic apparatus according to claim 1, wherein
the sensor includes a camera for detecting a line of sight of the user,
the plurality of devices includes a display device, and
the control unit performs the control for reducing the power consumption when it is detected that the detected line of sight of the user is not directed to the display device.

4. The electronic apparatus according to claim 3, wherein the control for reducing the power consumption includes reducing brightness of the display device.

5. The electronic apparatus according to claim 3, wherein the control unit performs the control for reducing the power consumption, and then causes a return from the control for reducing the power consumption when the sensor detects that the line of sight of the user is directed to the display device.

6. The electronic apparatus according to claim 1, wherein
the sensor includes a human sensor that detects whether the user is in front of the electronic apparatus, and
the control unit performs the control for reducing the power consumption when the user is not in front of the electronic apparatus.

7. The electronic apparatus according to claim 1, wherein
the plurality of devices includes at least one of an output device, an input device, and a storage device, and
the control for reducing the power consumption includes turning off at least one of the plurality of devices.

8. The electronic apparatus according to claim 1, wherein
the control unit includes a processor, and
the control for reducing the power consumption includes reducing operation frequency of the processor.

9. The electronic apparatus according to claim 1, wherein the control unit performs the control for reducing the power consumption, and then causes a return from the control for reducing the power consumption based on the use state.

10. The electronic apparatus according to claim 9, wherein
the plurality of devices includes an input device, and
the control unit performs the control for reducing the power consumption and then causes the return from the control for reducing the power consumption based on an input to the input device.

11. The electronic apparatus according to claim 3, wherein when the electronic apparatus is connected to an external display device, the control unit performs the control for reducing the power consumption of the external display device when the line of sight of the user is directed to the display device.

12. The electronic apparatus according to claim 3, wherein when the electronic apparatus is connected to an external display device, the control unit performs the control for reducing the power consumption of the display device when the line of sight of the user is directed to the external display device.
